(19) United States
(12) Patent Application Publication
(10) Pub. No.: US 2021/0405380 A1
(43) Pub. Date: Dec. 30, 2021

(54) Optical Systems with Resolution-Enhancing Holographic Elements

(71) Applicant: Apple Inc., Cupertino, CA (US)

(72) Inventors: Adam C. Urness, Boulder, CO (US); Byron R. Cocilovo, Sunnyvale, CA (US); Jonathan B. Pfeiffer, Lafayette, CO (US)

(21) Appl. No.: 17/475,080

(22) Filed: Sep. 14, 2021

Related U.S. Application Data
(63) Continuation of application No. PCT/US2020/062987, filed on Dec. 3, 2020.
(60) Provisional application No. 62/947,390, filed on Dec. 12, 2019.

(51) Int. Cl. G02B 27/01; F21V 8/00; G03H 1/02

(52) U.S. Cl. CPC G02B 27/0172; G02B 6/0026; G03H 2223/16; G02B 2027/0174; G03H 1/0248

(57) ABSTRACT

An electronic device may include an optical system that redirects light from a display module towards an eye box along an optical path. The optical path may include a holographic coupler and a resolution-enhancing holographic element. The holographic element may include a first set of holograms and the coupler may include a second set of holograms. The first set of holograms may be characterized by a first set of selectivity curves having first primary lobes. The second set of holograms may be characterized by a second set of selectivity curves having second primary lobes that overlap the first primary lobes. This may configure the holographic element to narrow the second selectivity curves by diffracting some of the light out of the optical path, thereby optimizing the resolution of images in the light provided to the eye box.

This application is a continuation of International Patent Application No. PCT/US2020/062987, filed Dec. 3, 2020, which claims the benefit of U.S. Provisional Patent Application No. 62/947,390, filed Dec. 12, 2019, which are hereby incorporated by reference herein in their entireties.

### BACKGROUND

This relates generally to optical systems and, more particularly, to optical systems for displays.

Electronic devices may include displays that present images close to a user's eyes. For example, devices such as virtual reality and augmented reality headsets may include displays with optical elements that allow users to view the displays.

It can be challenging to design devices such as these. If care is not taken, the components used in displaying content may be unsightly and bulky and may not exhibit desired levels of optical performance.

### SUMMARY

An electronic device such as a head-mounted device may have one or more near-eye displays that produce images for a user. The head-mounted device may be a pair of virtual reality glasses or may be an augmented reality headset that allows a viewer to view both computer-generated images and real-world objects in the viewer's surrounding environment.

The near-eye display may include a display module that generates light and an optical system that redirects the light from the display module towards an eye box along an optical path. The optical path may include a holographic coupler and a resolution-enhancing holographic element. The resolution-enhancing holographic element may include a first set of holograms and the holographic coupler may include a second set of holograms. The first set of holograms may be characterized by a first set of selectivity curves having first primary lobes. The second set of holograms may be characterized by a second set of selectivity curves having second primary lobes. The first set of holograms may be recorded so that the first primary lobes at least partially overlap the second primary lobes (e.g., as a function of incident angle or wavelength).

This may configure the resolution-enhancing holographic element to narrow the second selectivity curves of the holographic coupler by diffracting some of the light out of the optical path. This may serve to increase the resolution of images in the light provided to the eye box. If desired, the holographic coupler may include multiple sets of comb-shifted holograms recorded in different regions of a grating medium.

### BRIEF DESCRIPTION OF THE DRAWINGS

FIG. 1 is a diagram of an illustrative system having a display in accordance with some embodiments.

FIG. 2 is a top view of an illustrative optical system for a display that includes a waveguide with holographic couplers in accordance with some embodiments.

FIG. 3 is a diagram showing how a resolution-enhancing holographic element may be interposed on an optical path for a holographic coupler in accordance with some embodiments.

FIG. 4 is a plot that shows how an illustrative resolution-enhancing holographic element may narrow the selectivity curve of a given hologram in a holographic coupler in accordance with some embodiments.

FIG. 5 is a diagram showing how an illustrative resolution-enhancing holographic element may diffract light multiple times during propagation in accordance with some embodiments.

FIG. 6 is a diagram showing how multiple diffractions in a resolution-enhancing holographic element may decrease the amount of light transmitted to a holographic coupler in accordance with some embodiments.

FIG. 7 is a diagram showing how the selectivity curve of a given hologram in a holographic coupler may be narrowed by diffracting light multiple times in an illustrative resolution-enhancing holographic element in accordance with some embodiments.

FIG. 8 is a diagram showing how a resolution-enhancing holographic element may be interposed on an optical path for a holographic coupler that includes comb-shifted sets of holograms in accordance with some embodiments.

FIG. 9 is a momentum-space diagram of an illustrative holographic coupler having comb-shifted sets of holograms in accordance with some embodiments.

FIG. 10 is plot showing how an illustrative resolution-enhancing holographic element may narrow the selectivity curves of a holographic coupler having comb-shifted sets of holograms in accordance with some embodiments.

### DETAILED DESCRIPTION

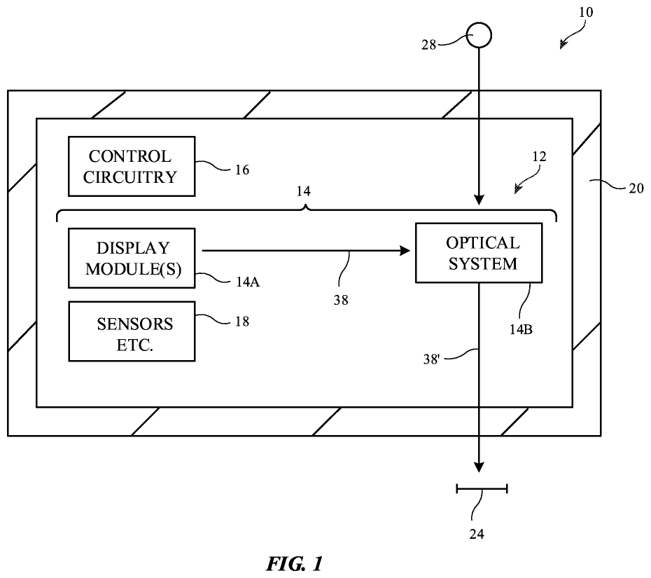

An illustrative system having a device with one or more near-eye display systems is shown in FIG. 1. System 10 may be a head-mounted device having one or more displays such as near-eye displays 14 mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B. Display modules 14A may be mounted in a support structure such as support structure 20. Each display module 14A may emit light 38 (image light) that is redirected towards a user's eyes at eye box 24 (as light 38′) using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 14A may be liquid crystal displays, organic light-emitting diode displays, light-emitting diode displays, micro light-emitting diode displays, organic light-emitting diode displays, laser-based displays, reflective displays, or displays of other types. Optical systems 14B may form lenses that allow a viewer (e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 28 to be combined optically with virtual (computer-generated) images such as virtual images in image light 38. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement which a camera captures real-world images of object 28 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

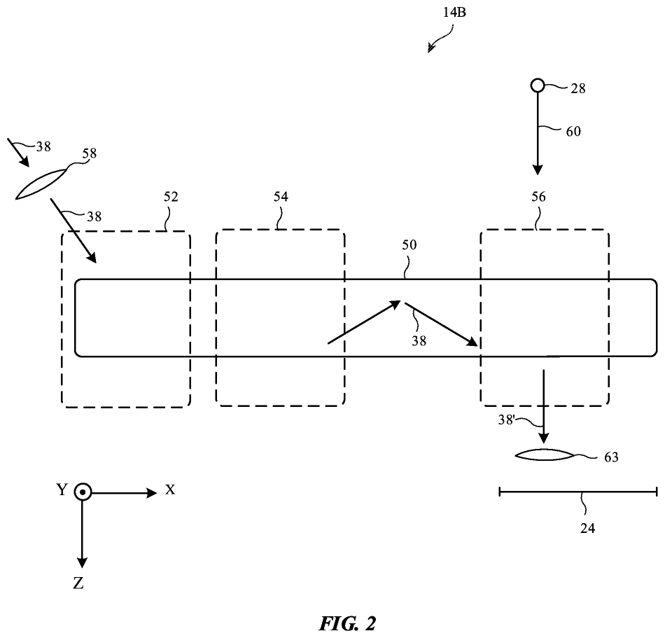

FIG. 2 is a top view of an illustrative optical system 14B that may be used in system 10 of FIG. 1. As shown in FIG. 2, optical system 14B may include optical elements such as waveguide 50, input optics 58, output optics 63, input coupler 52, cross coupler 54, and output coupler 56. Input optics 58 may include collimating lenses or other optical components that pass image light 38 to input coupler 52. Image light 38 may be provided to optical system 14B by a display unit in display module 14A (FIG. 1). The display unit may be a display unit based on a liquid crystal display, organic light-emitting diode display, light-emitting diode display, micro light-emitting diode display, micro organic light-emitting diode display, cathode ray tube, plasma display, projector display (e.g., a projector based on an array of micromirrors), liquid crystal on silicon display, or other suitable type of display. Optical system 14B may be used to present light 38 output from the display unit to eye box 24.

Waveguide structures such as waveguide 50 in optical system 14B may be formed from one or more stacked layers of polymer, glass, or other transparent substrates capable of guiding light via total internal reflection. Input coupler 52, cross coupler 54, and output coupler 56 may each be partially or completely embedded within waveguide 50 or mounted to a surface of waveguide 50. Some of optical couplers 52, 54, and 56 may be mounted to a surface of waveguide 50 whereas others of couplers 52, 54, and 56 are embedded within waveguide 50. One or more of couplers 52, 54, and 56 may be omitted if desired. Output optics 63 may include lenses that help to focus light 38 coupled out of waveguide 50 by output coupler 56 onto eye box 24. Input optics 58 and/or output optics 63 may be omitted if desired.

Input coupler 52 may be configured to couple light 38 from the display module into waveguide 50, whereas output coupler 56 may be configured to couple light 38 from within waveguide 50 out of waveguide 50 and towards eye box 24 (as light 38′). For example, when light 38 from input optics 58 strikes input coupler 52, input coupler 52 may redirect light 38 so that the light propagates within waveguide 50 via total internal reflection towards output coupler 56 (e.g., in the direction of the X axis). When light 38 strikes output coupler 56, output coupler 56 may redirect light 38 out of waveguide 50 towards eye box 24 (e.g., along the Z axis as light 38′).

In the example of FIG. 2, cross coupler 54 is optically interposed between input coupler 52 and output coupler 56. In this example, input coupler 52 may redirect light 38 towards cross coupler 54. Cross coupler 54 may expand light 38 in a first direction and may also couple (redirect) the expanded light back into waveguide 50. Waveguide 50 propagates the light expanded by cross coupler 54 via total internal reflection to output coupler 56. If desired, output coupler 56 may then expand the light received from cross coupler 54 in a second direction that is different from (e.g., perpendicular to) the first direction. Output coupler 56 may, if desired, provide an optical power to the light coupled out of the waveguide. Consider an example in which the light 38 coupled into waveguide 50 by input coupler 52 includes a pupil of light. Expansion of light 38 by cross coupler 54 and output coupler 56 may serve to expand the pupil in multiple (e.g., orthogonal) dimensions, thereby allowing a relatively large eye box 24 to be filled with pupils of light 38 with a sufficient and substantially uniform intensity across the entire area of the eye box.

Input coupler 52, cross coupler 54, and output coupler 56 may be based on reflective and refractive optics or may be based on holographic (e.g., diffractive) optics. In arrangements where couplers 52, 54, or 56 are formed from reflective and refractive optics, the couplers may include one or more reflectors (e.g., an array of micromirrors, partial mirrors, or other reflectors). In arrangements where couplers 52, 54, or 56 are based on holographic optics, couplers 52, 54, and 56 may include holographic media such as photopolymers, gelatin such as dichromated gelatin, silver halides, holographic polymer dispersed liquid crystal, or other suitable volume holographic media. Holographic recordings (e.g., holographic phase gratings sometimes referred to herein as holograms) may be stored in the holographic media. The holographic media may sometimes be referred to herein as grating media.

A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of grating medium if desired. The holographic phase gratings may be, for example, volume holograms in the grating medium.

If desired, one or more of couplers 52, 54, and 56 may be implemented using other types of diffraction grating structures such as surface relief grating structures. Surface relief grating structures include diffraction gratings (e.g., surface relief gratings) that are mechanically cut, etched, or otherwise formed in a surface relief grating medium. The surface relief gratings diffract light that is incident upon the surface relief gratings. Rather than modulating index of refraction in the grating medium (as performed to create holographic phase gratings such as volume holograms), surface relief gratings are produced by varying the physical thickness of the medium across its lateral area. Multiple surface relief gratings (e.g., two surface relief gratings) may be multiplexed within the same volume of surface relief grating medium if desired. Meta-gratings may be used in another suitable arrangement.

In one suitable arrangement that is sometimes described herein as an example, input coupler 52 is a non-diffractive input coupler (e.g., an input coupler that does not include diffraction gratings such as surface relief gratings or holographic phase gratings). For example, input coupler 52 may include an input prism (e.g., a transmissive or reflective prism), an angled surface (edge) of waveguide 50, etc. Use of a non-diffractive input coupler such as an input prism may allow light 38 to be coupled into waveguide 50 without producing the chromatic dispersion that is otherwise associated with input-coupling using diffractive elements. In another suitable arrangement, input coupler 52 may be formed using diffraction gratings such as volume holograms or other grating structures. In these scenarios, any chromatic dispersion introduced by the input coupler may be reversed by the output coupler in diffracting the light out of the waveguide (e.g., in a scenario where the output coupler includes holographic phase gratings such as volume holograms).

Cross coupler 54 may include diffractive grating structures that diffract the light 38 coupled into waveguide 50 by the (non-diffractive) input coupler 52. The grating structures in cross coupler 54 may include surface relief grating structures (e.g., one or more surface relief gratings) or phase grating structures such as volume holographic grating structures (e.g., a set of at least partially overlapping volume holograms). In one suitable arrangement, the grating structures in cross coupler 54 may be configured to diffract light 38 an even number of times. At least one of the diffractions may serve to expand light 38 in a first direction (e.g., along the Y axis into and/or out of the plane of FIG. 2). At least one of the diffractions may serve to redirect the expanded light back into waveguide 50 at an angle such that the light propagates by total internal reflection to output coupler 54. By diffracting the light an even number of times, any chromatic dispersion effects associated with diffracting the light one time can be reversed by diffracting the light a corresponding subsequent time. This may serve to mitigate chromatic dispersion of the light that is conveyed to output coupler 56.

Output coupler 56 may include diffractive grating structures such as volume holographic grating structures or other holographic phase gratings. In another suitable arrangement, output coupler 56 may include reflective mirror structures such as a louvred mirror. Examples in which output coupler 56 includes volume holographic grating structures (volume holograms) is described herein as an example. Output coupler 56 may reflect or diffract light 38. The reflection/diffraction of light 38 by output coupler 56 may serve to expand light 38 in a second direction (e.g., along the X axis) and to couple the expanded light out of waveguide 50 towards eye box 24. Optical system 14B need not perform light (pupil) expansion in one or both of these dimensions if desired.

In the example of FIG. 2, waveguide 50 is an optical combiner that combines real-world light 60 (sometimes referred to herein as environmental light 60 or world light 60) with image light 38 from display module 14A (e.g., for an augmented reality display system). In this scenario, output coupler 56 may provide light 38′ to eye box 24. Light 38′ may include both the image light 38 that propagates down waveguide 50 via total internal reflection and world light 60 from external real-world objects 28 (e.g., light 38′ may superimpose digitally-generated image data with light from a real world scene in front of system 10).

In this way, an optical path may be defined for light 38 from display module 14A (FIG. 1) to eye box 24 (e.g., light 38 propagates along the optical path from display module 14A to eye box 24). Input coupler 52, cross coupler 54, and output coupler 56 are interposed on this optical path. In scenarios where input coupler 52, cross coupler 54, or output coupler 56 is formed from holographic optical elements (e.g., volume holograms), the couplers may sometimes be referred to herein as holographic couplers (e.g., holographic input coupler 52, holographic cross coupler 54, and holographic output coupler 56).

In practice, holograms used to form input coupler 52, cross coupler 54, and/or output coupler 56 do not diffract all of the light 38 incident on the holograms. For example, the holograms have corresponding Bragg peaks at particular wavelengths and input (incident) angles. At the Bragg peaks, the holograms will have peak diffraction efficiency onto corresponding output angles. However, the holograms generally do not diffract much light off of the Bragg peak (e.g., outside of a primary lobe associated with the Bragg peak). In general, it may be desirable to maximize throughput, uniformity, and field of view of the light 38 provided by display module 14A at eye box 24 (e.g., to ensure that images displayed at eye box 24 are as bright and uniform as possible). By multiplexing multiple holograms with different Bragg peaks in couplers 52, 54, and/or 56, the holograms can diffract as much of light 38 as possible towards eye box 24, thereby maximizing throughput, uniformity, and field of view. However, if care is not taken, the width of the Bragg peaks for the holograms (e.g., the primary lobes associated with the Bragg peaks) may limit the ultimate resolution of the images displayed at eye box 24. If desired, optical system 14B may include one or more resolution-enhancing holographic elements that increase the ultimate resolution of the images displayed at eye box 24.

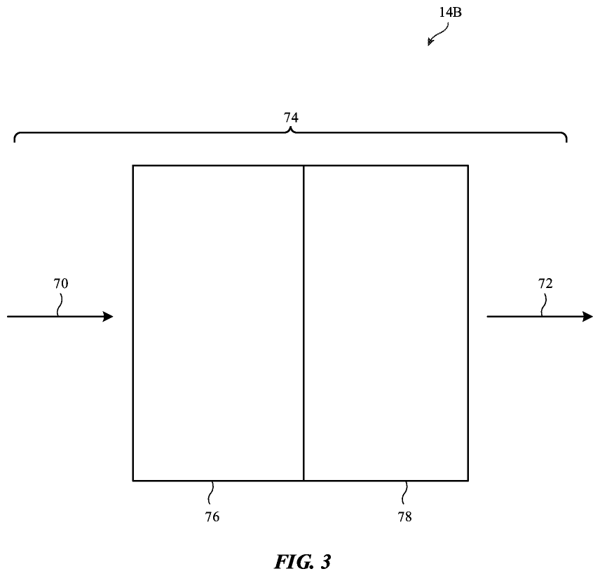

FIG. 3 is a diagram showing optical system 14B may include a resolution-enhancing holographic element that increase the resolution of the images displayed at eye box 24. As shown in FIG. 3, optical system 14B includes an optical path such as optical path 74. Light 38 (FIG. 2) is incident upon optical path 74, as shown by ray 70. Light 38 is output from optical path 74, as shown by ray 72 (e.g., as output light 38′ provided to eye box 24 of FIG. 2). Optical path 74 may include any desired portions of waveguide 50, portions of optical system 14B separate from waveguide 50, input coupler 52, cross coupler 54, and/or output coupler 56 of FIG. 2. A holographic optical element such as holographic coupler 78 may be interposed on optical path 74. Holographic coupler 78 may be used to form input coupler 52, cross coupler 54, and/or output coupler 56 of FIG. 2. A scenario in which holographic coupler 78 forms output coupler 56 of FIG. 2 is described herein as an example.

Holographic coupler 78 may include multiple diffractive grating structures. An example in which holographic coupler 78 includes multiple volume holograms (e.g., multiplexed volume holograms) is described herein as an example. The volume holograms may be at least partially or completely overlapping (superimposed) within a corresponding volume of grating (recording) medium. Holographic coupler 78 may diffract light 38 to couple the light out of waveguide 50 and towards the eye box (e.g., as shown by ray 72).

As shown in FIG. 3, a resolution-enhancing holographic element such as resolution-enhancing holographic element 76 may also be interposed on optical path 74. Resolution-enhancing holographic element 76 may be interposed on optical path 74 before (prior) to holographic coupler 78. For example, light 38 (ray 70) may propagate through resolution-enhancing holographic element 76 prior to propagating through holographic coupler 78. Resolution-enhancing holographic element 76 may include multiple diffractive grating structures such as multiple holograms. Examples in which resolution-enhancing holographic element 76 includes multiple (e.g., multiplexed) volume holograms is described herein as an example.

The volume holograms in resolution-enhancing holographic element 76 may diffract a first portion of light 38 away from holographic coupler 78 while also allowing a second portion of light 38 to propagate (e.g., while also transmitting a second portion of light 38) to holographic coupler 78 (e.g., without diffracting the second portion of light 38 at resolution-enhancing holographic element 76). Holographic coupler 78 may diffract the second portion of light 38 transmitted by resolution-enhancing holographic element 76 towards eye box 24 (e.g., as ray 72 or light 38′ of FIG. 2). The first portion of light 38 that is diffracted by resolution-enhancing holographic element 76 away from holographic coupler 78 may be directed (diffracted) towards a light sink, an optical absorber, or any other desired location outside of optical path 74. The first portion of light 38 that is diffracted away from holographic coupler 78 by resolution-enhancing holographic element 76 may serve to increase the resolution of the images in light 38 that are provided to eye box 24 (e.g., while sacrificing some of the total throughput of light 38 that is provided at eye box 24).

Resolution-enhancing holographic element 76 may be provided at any desired location in optical path 74. For example, resolution-enhancing holographic element 76 may be optically interposed (e.g., interposed on optical path 74) between display module 14A and input optics 58 of FIG. 2, between input optics 58 and waveguide 50 (e.g., input coupler 52) of FIG. 2, may be located within input coupler 52 of FIG. 2, may be optically interposed between input coupler 52 and cross coupler 54 (e.g., within, on a surface of, or external to waveguide 50), may be optically interposed between input coupler 52 and output coupler 56 of FIG. 2 (e.g., within, on a surface of, or external to waveguide 50 in scenarios where cross coupler 54 is omitted), may be optically interposed between cross coupler 54 and output coupler 56 (e.g., within, on a surface of, or external to waveguide 50), may be located within cross coupler 54, or may be located within output coupler 56 (e.g., a portion of output coupler 56 prior to the holograms in holographic coupler 78 of FIG. 3).

If desired, resolution-enhancing holographic element 76 and holographic coupler 78 may be formed within the same layer of grating medium. In this example, the holograms in resolution-enhancing holographic element 76 may be located within a first region of the grating medium whereas the holograms in holographic coupler 78 may be located in a second region of the grating medium (e.g., a second region that is non-overlapping with respect to the first region). The first and second regions may be in direct contact with each other (e.g., may be formed from a contiguous portion of grating medium) or there may be a region of grating medium interposed between the first and second regions (e.g., the first and second regions may be formed from non-contiguous portions of the grating medium). In another suitable arrangement, the first and second regions may be partially overlapping in the grating medium. In yet another suitable arrangement, resolution-enhancing holographic element 76 and holographic coupler 78 may be formed from different respective layers of grating media (e.g., layers of different grating media in the same waveguide or in different (separate) waveguides). The example of FIG. 3 is merely illustrative.

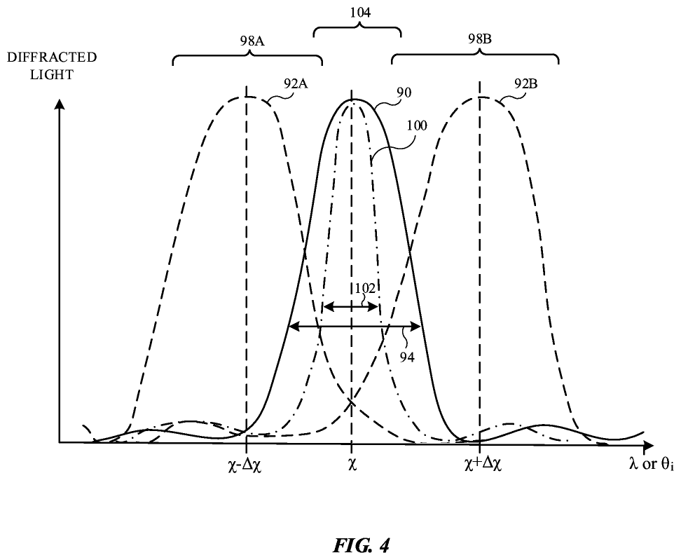

FIG. 4 is an illustrative plot showing how holograms in resolution-enhancing holographic element 76 may operate on light 38 that is provided to holographic coupler 78 (e.g., for maximizing the resolution of images at eye box 24). The horizontal axis of FIG. 4 plots wavelength or, equivalently, input (incident) angle Øᵢ. The vertical axis of FIG. 4 plots amount of diffracted light.

Selectivity curve 90 plots the amount of light diffracted by a given exemplary hologram in holographic coupler 78 of FIG. 3, in the absence of resolution-enhancing holographic element 76 of FIG. 3. As shown by selectivity curve 90, the hologram has a diffractive response peak (e.g., a Bragg peak or peak diffractive efficiency) at wavelength or incident angle X. When light 38 is incident upon the hologram with wavelength or incident angle X, the light is Bragg-matched to the hologram and the hologram will diffract the light at a corresponding output angle with peak diffractive efficiency. The output angle may, for example, be selected so that the hologram couples the light out of waveguide 50 and towards eye box 24.

The diffractive efficiency of the hologram has a finite width and rolls off as wavelength or incident angle increases or decreases away wavelength or incident angle X (as illustrated by primary lobe 104 of selectivity curve 90). Primary lobe 104 is characterized by a corresponding width 94 (e.g., a full-width half maximum). In practice, the greater the width 94 of primary lobe 104, the lower the maximum resolution achievable for the images in light 38 provided to eye box 24. In other words, if width 94 is excessively large, the images provided at eye box 24 may be undesirably low-resolution or blurry. In order to provide images at eye box 24 with higher resolution images, one or more holograms in resolution-enhancing holographic element 76 of FIG. 3 may serve to narrow the width 94 of selectivity curve 90 for the hologram in holographic coupling element 78.

In the example of FIG. 4, resolution-enhancing holographic element 76 includes a first hologram characterized by selectivity curve 92A and a second hologram characterized by selectivity curve 92B (sometimes referred to herein as first and second resolution-enhancing holograms). The first and second holograms in resolution-enhancing holographic element 76 may be completely overlapping (superimposed), partially overlapping (superimposed), or non-overlapping within a given volume of grating medium within resolution-enhancing holographic element 76, for example.

As shown by selectivity curve 92A, the first hologram in resolution-enhancing holographic element 76 has a response peak at wavelength or incident angle X-ΔX, which is offset from (e.g., less than) wavelength or incident angle X by margin ΔX. As shown by selectivity curve 92B, the second hologram in resolution-enhancing holographic element 76 has a response peak at wavelength or incident angle X+ΔX, which is offset from (e.g., greater than) wavelength or incident angle X by margin ΔX. The example of FIG. 4 is merely illustrative. Selectivity curves 92A and 92B may be offset from wavelength or incident angle X by the same margin ΔX or by different margins. Selectivity curve 92A has a corresponding primary lobe 98A. Selectivity curve 92B has a corresponding primary lobe 98B. Selectivity curves 92A, 92B, and 90 may have non-zero side lobes (e.g., second-order lobes) around the corresponding primary lobes. However, the effect of the side lobes may be negligible for the purposes described herein.

As shown in FIG. 4, margin ΔX may be selected so that primary lobe 98A of selectivity curve 92A overlaps with primary lobe 104 of the hologram in holographic coupler 78 (e.g., between X-ΔX and X). Similarly, margin ΔX may be selected so that primary lobe 98B of selectivity curve 92B overlaps with primary lobe 104 of the hologram in holographic coupler 78 (e.g., between X and X+ΔX). Because the first and second holograms in resolution-enhancing element 76 are located earlier in optical path 74 of FIG. 3 than holographic coupler 78, the first and second holograms in resolution-enhancing holographic element 76 will diffract a first portion of light 38 (e.g., light 38 that lies between X+ΔX and X and between X-ΔX and X in wavelength or incident angle space). The first and second holograms may direct the first portion of light 38 away from holographic coupler 78 (e.g., so that holographic coupler 78 does not receive the first portion of light 38). The first and second holograms in resolution-enhancing holographic element 76 may, for example, direct the first portion of light 38 to a light sink or absorber outside of optical path 74.

Because the first portion of light 38 is diffracted away from optical path 74 by the first and second holograms in resolution-enhancing holographic element 76, the hologram in holographic coupler 78 does not receive the first portion of light 38. This serves to narrow the effective diffractive response (e.g., the selectivity) of the hologram in holographic coupler 78 such that the hologram in holographic coupler 78 exhibits a narrowed selectivity curve such as dash-dotted selectivity curve 100 of FIG. 4. Selectivity curve 100 has a corresponding width 102 (e.g., a full width half maximum) that is narrower than width 94 of selectivity curve 90. Because width 102 is narrower than width 94, images in the light diffracted towards eye box 24 by the hologram in holographic coupler 78 (e.g., the hologram associated with selectivity curves 100) will exhibit a greater resolution than in scenarios where resolution-enhancing holographic element 76 is omitted (e.g., a greater resolution than would otherwise be achievable with selectivity curve 90). In other words, by diffracting light 38 at the edges of primary lobe 104 of selectivity curve 90 prior to the light hitting holographic coupler 78, resolution-enhancing holographic element 76 may serve to narrow the selectivity curve of the hologram in holographic coupler 78, thereby increasing the overall resolution and clarity of the images in the image light (e.g., image light 38′ of FIG. 2) provided to eye box 24. While this reduces the overall throughput of light provided at eye box 24, the improvement to image quality introduced by the increase in resolution more than compensates for the corresponding sacrifice in throughput.

The example of FIG. 4 is merely illustrative. In practice, holographic coupler 78 may include many holograms each with a corresponding selectivity curve such as selectivity curve 90 of FIG. 4 (e.g., selectivity curves at different values of wavelength and/or input angle X). Resolution-enhancing holographic element 76 may include one, two, or more than two holograms such as the first and second holograms associated with selectivity curves 92A and 92B of FIG. 4 for narrowing the selectivity curve for each of the holograms (or a subset of the holograms) in holographic coupler 78. Selectivity curves 90, 92A, and 92B may have other shapes.

If desired, resolution-enhancing holographic element 76 may diffract light 38 multiple times as light 38 propagates through resolution-enhancing holographic element 76. Each diffraction may increase the amount of light that is diffracted away from holographic coupler 78, thereby further narrowing width 102 of FIG. 4 and increasing the resolution of the images at eye box 24. FIG. 5 is a diagram showing how resolution-enhancing holographic element 76 may diffract light 38 multiple times as light 38 propagates through resolution-enhancing holographic element 76 and towards holographic coupler 78.

As shown by ray 70 of FIG. 5, light 38 may propagate through resolution-enhancing holographic element 76. For example, light 38 may propagate by total internal reflection down the length of resolution-enhancing holographic element 76 (e.g., resolution-enhancing holographic element 76 may be embedded within a waveguide such as waveguide 50 of FIG. 2). On each downward pass of ray 70, for example, holograms in resolution-enhancing holographic element 76 may diffract a portion of light 110 (e.g., based on selectivity curves 92A and 92B of FIG. 4) out of the optical path (e.g., out of the waveguide and towards a light absorber or elsewhere). The diffracted light no longer propagates through element 76 and will not be transmitted to or received at holographic coupler 78 (FIG. 3). The portion of the light that is not diffracted (e.g., that is transmitted) continues to propagate through element 76 via total internal reflection until reaching the holographic coupler.

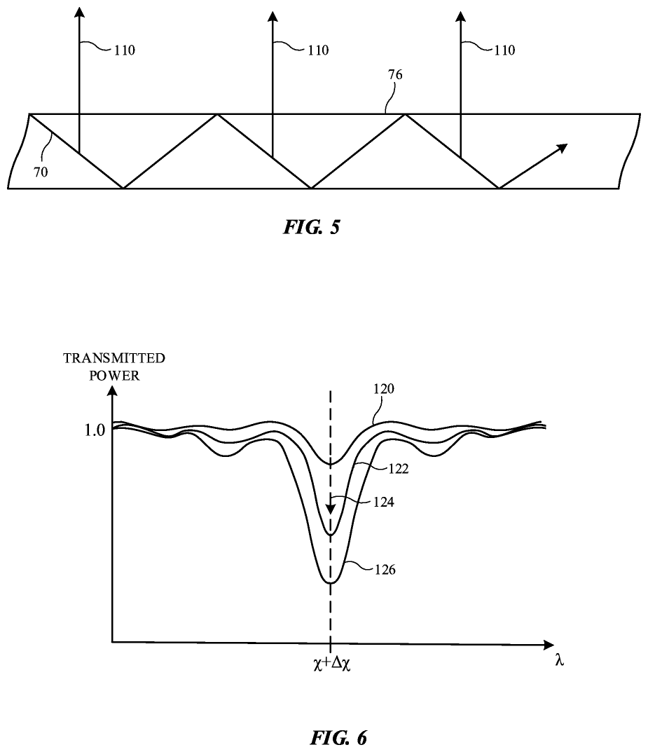

The example of FIG. 5 is merely illustrative. Resolution-enhancing holographic element 76 may diffract light 38 on the upward passes of ray 70 if desired. Resolution-enhancing holographic element 76 may diffract light 38 any desired number of times before light 38 is received at holographic coupler 78. FIG. 6 is a plot showing how each diffraction by the holograms in resolution-enhancing holographic element 76 affects the transmitted power of light 38 after passing through element 76.

In the example of FIG. 6, the horizontal axis plots wavelength and the vertical axis plots transmitted power after propagation through resolution-enhancing holographic element 76. The plot of FIG. 6 illustrates the hologram associated with selectivity curve 92B of FIG. 4 as an example (e.g., having a diffractive response peak at wavelength X+ΔX). A similar plot may be produced for the hologram corresponding to selectivity curve 92A of FIG. 4 and/or with incident angle plotted on the horizontal axis rather than wavelength.

Curve 120 plots the amount of transmitted power after a first diffraction by resolution-enhancing holographic element 76. There is a reduction in transmitted light at wavelength X+ΔX because the first diffraction has diffracted some of light 38 out of the optical path (e.g., as diffracted light 110 of FIG. 5). Curve 122 plots the amount of transmitted power after a second diffraction by resolution-enhancing holographic element 76 and curve 126 plots the amount of transmitted power after a third diffraction by resolution-enhancing holographic element 76. As shown by curves 120, 122, and 126, increasing the number of diffractions performed by resolution-enhancing holographic element 76 as light 38 propagates through resolution-enhancing holographic element 76 serves to further reduce the transmitted power of light 38 incident upon holographic coupler 78, as shown by arrow 124 (e.g., the transmitted power may be approximately zero at X+ΔX).

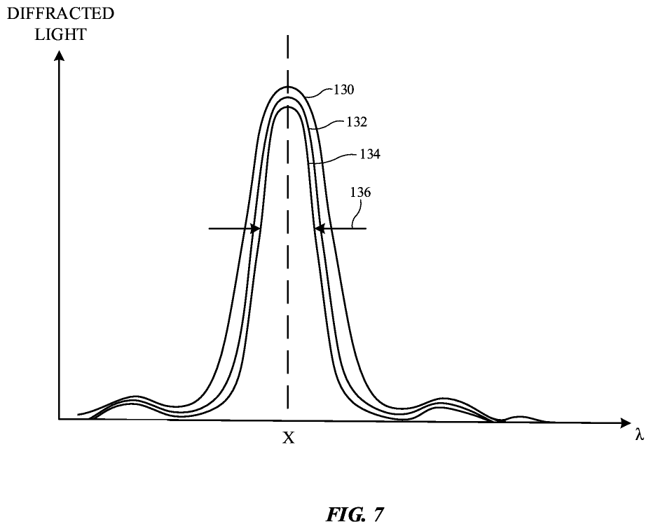

FIG. 7 plots the effect of decreasing transmitted power, as shown in FIG. 6, on the amount of light diffracted by holographic coupler 78. Selectivity curve 130 of FIG. 7 plots the amount of light diffracted by holographic coupler 78 at wavelength X in the absence of holographic coupler 78 (e.g., for the hologram in holographic coupler 78 associated with selectivity curves 90 and 100 of FIG. 4). Selectivity curve 132 plots the amount of diffracted light in scenarios where resolution-enhancing holographic element 76 diffracts light 38 one time. Selectivity curve 134 plots the amount of diffracted light in scenarios where resolution-enhancing holographic element 76 diffracts light 38 twice. As shown by selectivity curves 130-134 (and curves 120, 122, and 126 of FIG. 6), increasing the number of diffractions in resolution-enhancing holographic element 76 decreases the amount of light transmitted through element 76 and thus narrows the width (in wavelength or incident angle) of the selectivity curve associated with the hologram in holographic coupler 78, as shown by arrows 136 of FIG. 7. In this way, increasing the number of diffractions in resolution-enhancing holographic element 76 may serve to further narrow/tighten width 102 of selectivity curve 100 of FIG. 4, thereby further increasing resolution of the images provided at eye box 24.

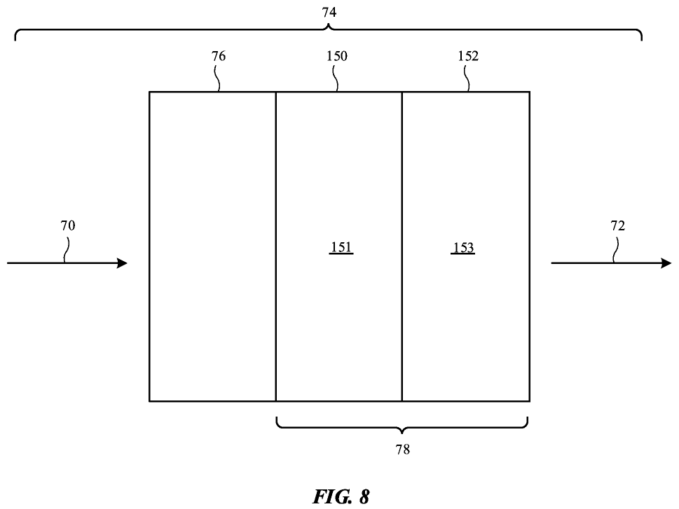

If desired, holographic coupler 78 may include multiple sets of comb-shifted holograms. FIG. 8 is a diagram showing how holographic coupler 78 may include multiple sets of comb-shifted holograms. As shown in FIG. 8, holographic coupler 78 may include a first set of holograms 151 in region 150 of holographic coupler 78 and a second set of holograms 153 in region 152 of holographic coupler 78. Regions 150 and 152 may, for example, be laterally offset from each other such that there is little or no overlap of the holograms between regions. In another suitable arrangement, region 150 may partially overlap region 152. If desired, each hologram in set 151 may lie within the same physical volume of grating medium (e.g., each hologram may overlap and be superimposed with the other holograms in set 151). Similarly, if desired, each hologram in set 153 may lie within the same physical volume of grating medium (e.g., each hologram may overlap and be superimposed with the other holograms in set 153). Incoming light 38, as shown by ray 70, may pass through resolution-enhancing holographic element 76 and then through region 150, followed by region 152, before being output (as shown by ray 72). The light 38 that is not diffracted by the set 151 of holograms in region 150 may propagate to region 152.

The magnitude of a difference in grating frequency between any two holograms in sets 151 and 153 described herein may sometimes be referred to as frequency gap |ΔK_{G}|. Frequency gap |ΔK_{G}| can be a useful metric for describing hologram “spacing” (e.g. how close to each other in momentum-space the grating vectors for the any two holograms are). The frequency gap |ΔK_{G}| between a given hologram and an adjacent hologram (e.g., in momentum-space) may sometimes be referred to as the adjacent frequency gap |ΔK_{G}|.

Among a set of multiple holograms (e.g., a set of volume holographic gratings), each hologram in the set has a corresponding grating vector in momentum-space. The grating vector has a corresponding grating vector magnitude K_{G}. A first hologram in the set is sometimes referred to as being “adjacent” to a second hologram in the set of holograms when the second hologram has the next highest or next lowest grating vector magnitude K_{G} relative to the grating vector magnitude of the first hologram (among the holograms in the set). Each hologram in the set may be separated from one or two adjacent holograms in the set by an adjacent frequency gap |ΔK_{G}|. The adjacent frequency gap |ΔK_{G}| may be the magnitude of the difference between the grating vector magnitudes K_{G} for the adjacent holograms. For example, the first hologram in the set may have a first grating vector magnitude K_{G1}, the second hologram in the set may have a second grating vector magnitude K_{G2}, and the first grating vector magnitude K_{G1} may be separated from the second grating vector magnitude K_{G2} in momentum-space by the adjacent frequency gap |ΔK_{G|.}

Each hologram in the set is separated from one or more other holograms in the set by a corresponding adjacent frequency gap |ΔK_{G}| (e.g., the adjacent frequency gaps across the set need not be uniform). In some embodiments, the mean adjacent frequency gap |ΔK_{G}| for the entire set of holograms may influence the performance of the holographic coupler. The grating vector magnitude K_{G} of a given hologram may determine the grating frequency for the hologram (e.g., the frequency of refractive index modulations in the grating medium in physical space as well as the wavelength of light that is Bragg-matched to the hologram). Grating vector magnitude K_{G} may therefore sometimes be referred to herein as grating frequency K_{G}. Each hologram in the set of holograms has a corresponding grating frequency K_{G}. The direction of the grating vector associated with grating frequency K_{G} may give the direction (orientation) of the refractive index modulations in the grating medium in physical space, as well as the angle at which the hologram diffracts light. Grating frequency K_{G} and the frequency gap |ΔK_{G}| may be expressed in various units, including, but not limited to, radians per meter (rad/m) and/or sinc peak to sinc nulls.

A relatively small mean adjacent frequency gap |ΔK_{G}| for the set of holograms can correspond to relatively high image fidelity (e.g., for the entire set of holograms). However, where the mean adjacent frequency gap |ΔK_{G}| for a set of holograms is relatively small, the total number of holograms in the set is larger in order to span a given adjacent frequency gap |ΔK_{G}| range for the set. Moreover, given that recording capacity for grating mediums is typically limited by dynamic range (usually expressed as Δn), recording more holograms in a set usually means that each hologram in the set is weaker (i.e., is recorded more faintly in the medium). Accordingly, tension exists between having relatively small adjacent frequency gaps |ΔK_{G}| for a set of holograms (which requires more holograms, other things being equal), and having larger adjacent frequency gaps |ΔK_{G}| for the set, which allows recording of fewer, but stronger holograms.

Fewer, stronger holograms typically result in stronger reflectance or stronger output coupling depending on the geometry and skew axis of the skew mirror. In the reflection geometry, where the light has only one interaction with the skew mirror, the maximum reflectance occurs when the number of holograms is equivalent to the M# of the material such that each hologram has 100% diffraction efficiency. In the waveguide geometry there are multiple interactions with the holographic recording and the number of interactions is dependent on the guided angle, thus maximum output coupling is more complicated. To optimize eye box efficiency (e.g., the ratio of the amount of light in the “eye box” and what is coupled in), lower densities of holograms are used. However, this results in significant intensity variation across the eye box. Thus, in the waveguide geometry, there is a tension between large eye box efficiency and intensity uniformity across the eye box.

In order to mitigate these issues, holographic coupler 78 may be configured to exhibit larger diffraction efficiency for a larger range of angles and/or for a larger range of wavelengths within the band of the read source by the method of “comb shift” writing. In some embodiments, skew mirror hologram comb shift writing and sparsely writing holograms across the designed field of view (FOV) may reduce medium dynamic range (frequently expressed as An) required to achieve a desired level of performance, or increase the diffraction efficiency obtainable. Sparse writing typically refers to multiple holograms having adjacent frequency gap |ΔK_{G}| of greater than 4.0 sinc peak to sinc nulls. In some embodiments, sparsely written holograms have adjacent frequency gaps |ΔK_{G}| around 12. In some embodiments, sparsely written holograms have adjacent frequency gaps |ΔK_{G}| in a range from 8.0 to 12 sinc peak to sinc nulls.

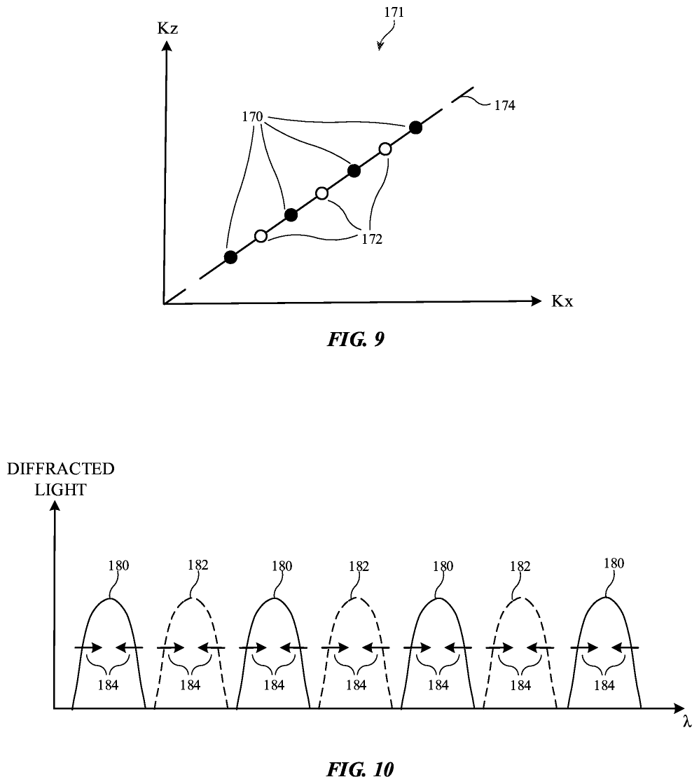

As shown in FIG. 9, momentum-space diagram 171 plots the distribution of holograms in holographic coupler 78 of FIG. 8 (e.g., for light diffracted in a single direction/pixel). Each hologram in set 151 of FIG. 8 may have a corresponding grating frequency as shown by points 170 in momentum-space diagram 171 of FIG. 9 (e.g., each point 170 has an associated grating frequency corresponding to the distance from the point to the origin). Each grating frequency may be separated from an adjacent grating frequency of the set 151 of holograms by a respective adjacent frequency gap |ΔK_{G}|. There may be no holograms in set 151 of region 150 that lie within the adjacent frequency gaps.

In the absence of other sets of holograms in other regions of holographic coupler 78, adjacent frequency gaps (e.g., frequency gaps in momentum-space between each adjacent pair of points 170) may be present between each grating frequency of set 151. However, the holograms in set 153 may be comb-shifted with respect to the holograms in set 151. For example, each hologram in set 153 may have a corresponding grating frequency as shown by points 172 in momentum-space diagram 171 (e.g., each point 172 has an associated grating frequency corresponding to the distance from the point to the origin). The grating frequencies associated with points 172 may be selected to lie within the adjacent frequency gaps between the grating frequencies associated with points 170. The grating vectors for each hologram in sets 151 and 153 may be oriented in the same direction (e.g., along axis 174). In this way, each of the holograms in sets 151 and 153 may exhibit a substantially constant (uniform) reflective axis for reflecting light in a desired direction (e.g., towards an eye box).

FIG. 10 plots diffracted light as a function of wavelength for the first and second sets of holograms in holographic coupler 78. Each hologram in set 151 may diffract light corresponding to a respective selectivity curve peak 180 in FIG. 10. Because the grating frequencies of set 153 (e.g., as shown by points 172 of FIG. 9) lie within the frequency gaps between the grating frequencies associated with points 170 of FIG. 9, each hologram in set 153 may diffract light at wavelengths lying in the nulls between the selectivity curve peaks 180 associated with set 151 and the grating frequencies associated with points 170 (e.g., set 153 may produce selectivity curve peaks 182 within spectrum nulls between each adjacent pair of selectivity curve peaks 180 of FIG. 10). Because light 38 at these wavelengths remains after first passing through set 151 (e.g., because light at these wavelengths is not diffracted by set 151), set 153 may diffract light at these wavelengths in a desired direction (e.g., towards the eye box).

In other words, splitting holographic coupler 78 into two distinct regions 150 and 152 each having respective sets 151 and 153 of holograms with grating frequencies that are slightly shifted along a skew axis from one another may cause the diffraction peaks from the two regions to become interleaved with respect to each other (e.g., as shown in FIG. 10). Diffraction from region 150 does not deplete the light 38 that may then be diffracted by region 152. This results in a greater amount of light within the bandwidth of the light source being diffracted to the eye box, due to the shifted grating frequencies between the regions.

As shown in FIG. 10, resolution-enhancing holographic element 76 of FIG. 8 may include holograms that diffract light 38 away from the optical path prior to the light being incident on region 150 of holographic coupler 78, which serves to narrow selectivity curve peaks 180 and 182, as shown by arrows 184. For example, resolution-enhancing holographic element 76 may include a pair of holograms having primary lobes (e.g., as shown by selectivity curves 92A and 92B of FIG. 4) that overlap the primary lobe of each selectivity curve peak 180 and 182 in FIG. 10, thereby serving to narrow the response peaks (as shown by arrows 184). This is merely illustrative. If desired, resolution-enhancing holographic element 76 may narrow all or some (e.g., a subset of) selectivity curve peaks 180 and 182, may only narrow some or all of selectivity curve peaks 180 (e.g., without affecting selectivity curve peaks 182), may only narrow some or all of selectivity curve peaks 182 (e.g., without affecting selectivity curve peaks 180), etc. Selectivity curve peaks 180 and 182 may have other shapes. In this way, holographic coupler 78 may perform comb-shifting operations while resolution-enhancing holographic element 76 also maximizes the resolution of images displayed at eye box 24.

In accordance with an embodiment, an optical system configured to direct image light generated by a display module towards an eye box along an optical path, the optical system is provided that includes first and second holograms in the optical path, a waveguide, and an optical coupler on the waveguide and having a third hologram in the optical path, the third hologram being configured to receive the image light from the first and second holograms, the first hologram has a first selectivity curve with a first primary lobe, the second hologram has a second selectivity curve with a second primary lobe, the third hologram has a third selectivity curve with a third primary lobe, and the first and second primary lobes overlap the third primary lobe.

In accordance with another embodiment, the first primary lobe has a first peak at a first wavelength, the second primary lobe has a second peak at a second wavelength, the third primary lobe has a third peak at a third wavelength, the third wavelength is greater than the first wavelength, and the third wavelength is less than the second wavelength.

In accordance with another embodiment, the waveguide includes a layer of grating medium and the first, second, and third holograms are located within the layer of grating medium.

In accordance with another embodiment, the first and second holograms are superimposed in a first region of the layer of grating medium and the third hologram is in a second region of the layer of grating medium.

In accordance with another embodiment, the optical coupler includes a first set of holograms located in a first portion of the second region and a second set of holograms located in a second portion of the second region, the first set of holograms includes the third hologram, and the second set of holograms is comb-shifted with respect to the first set of holograms.

In accordance with another embodiment, the first and second holograms are configured to transmit a first portion of the image light to the third hologram and the first and second holograms are configured to diffract a second portion of the image light out of the optical path.

In accordance with another embodiment, the optical system includes a light sink, the first and second holograms are configured to diffract the second portion of the image light towards the light sink.

In accordance with another embodiment, the first and second holograms are each configured to diffract the image light a plurality of times.

In accordance with another embodiment, the optical coupler includes an output coupler configured to couple the image light out of the waveguide and towards the eye box.

In accordance with another embodiment, the optical coupler includes a coupler selected from the group consisting of an input coupler and a cross coupler.

In accordance with an embodiment, an optical system configured to direct light generated by a display module towards an eye box along an optical path, the optical system is provided that includes a waveguide configured to propagate the light via total internal reflection,

a holographic output coupler configured to couple the light out of the waveguide and towards the eye box, and a resolution-enhancing holographic element interposed on the optical path between the display module and the holographic output coupler, the resolution-enhancing optical element is configured to narrow a selectivity curve of the holographic output coupler prior to the holographic output coupler coupling the light out of the waveguide.

In accordance with another embodiment, the resolution-enhancing holographic element is configured to transmit a first portion of the light along the optical path, the holographic output coupler is configured to couple the second portion of the light out of the waveguide and towards the eye box, and the resolution-enhancing holographic element is configured to diffract a second portion of the light away from the optical path.

In accordance with another embodiment, the selectivity curve of the holographic output coupler has a first primary lobe, the resolution-enhancing holographic element includes a hologram, the hologram has an additional selectivity curve with a second primary lobe, and the second primary lobe overlaps the first primary lobe.

In accordance with another embodiment, the holographic output coupler includes a plurality of holograms.

In accordance with another embodiment, the hologram of the resolution-enhancing holographic element is configured to diffract the light multiple times.

In accordance with another embodiment, the optical system includes a layer of grating medium in the waveguide, the holographic output coupler and the resolution-enhancing holographic element are located in the layer of grating medium.

In accordance with another embodiment, the resolution-enhancing holographic element is located in a first region of the layer of grating medium, the holographic output coupler is located in a second region of the layer of grating medium, and the first and second regions of the layer of grating medium are contiguous.

In accordance with another embodiment, the holographic output coupler includes a first set of at least partially-overlapping volume holograms and the resolution-enhancing holographic element includes a second set of at least partially-overlapping volume holograms.

In accordance with an embodiment, an optical system configured to direct light generated by a display module towards an eye box, the optical system is provided that includes a waveguide configured to propagate the light via total internal reflection, a grating medium in the waveguide, an output coupler configured to couple the light out of the waveguide and towards the eye box, the holographic output coupler includes a first set of holograms in a first region of the grating medium, each of the holograms in the first set at least partially overlaps each of the other holograms in the first set, each of the holograms in the first set has a different respective grating frequency from a first set of grating frequencies, and the holograms in the first set are characterized by a first set of selectivity curves, a second set of holograms in a second region of the grating medium, each of the holograms in the second set at least partially overlaps each of the other holograms in the second set, each of the holograms in the second set has a different respective grating frequency from a second set of grating frequencies, the second set of grating frequencies being located within adjacent frequency gaps between the grating frequencies in the first set of grating frequencies, and the holograms in the first set are characterized by a second set of selectivity curves, and a third set of holograms in a third region of the grating medium, the first region is interposed between the second and third regions of the grating medium, and the third set of holograms is configured to narrow each of the selectivity curves in the first set of selectivity curves.

In accordance with another embodiment, the third set of holograms is configured to narrow each of the selectivity curves in the second set of selectivity curves.

The foregoing is merely illustrative and various modifications can be made to the described embodiments. The foregoing embodiments may be implemented individually or in any combination.

What is claimed is:

1. An optical system configured to display image light generated by a display module along an optical path, the optical system comprising:
first and second holograms in the optical path;
a waveguide; and
an optical coupler on the waveguide and having a third hologram in the optical path, the third hologram being configured to receive the image light from the first and second holograms, wherein:
the first hologram has a first selectivity curve with a first primary lobe,
the second hologram has a second selectivity curve with a second primary lobe,
the third hologram has a third selectivity curve with a third primary lobe, and
the first and second primary lobes overlap the third primary lobe.

2. The optical system of claim 1, wherein the first primary lobe has a first peak at a first wavelength, the second primary lobe has a second peak at a second wavelength, the third primary lobe has a third peak at a third wavelength, the third wavelength is greater than the first wavelength, and the third wavelength is less than the second wavelength.

3. The optical system of claim 1, wherein the waveguide comprises a layer of grating medium and wherein the first, second, and third holograms are located within the layer of grating medium.

4. The optical system of claim 3, wherein the first and second holograms are superimposed in a first region of the layer of grating medium and wherein the third hologram is in a second region of the layer of grating medium.

5. The optical system of claim 4, wherein the optical coupler comprises a first set of holograms located in a first portion of the second region and a second set of holograms located in a second portion of the second region, wherein the first set of holograms includes the third hologram, and wherein the second set of holograms is comb-shifted with respect to the first set of holograms.

6. The optical system of claim 1, wherein the first and second holograms are configured to transmit a first portion of the image light to the third hologram and wherein the first and second holograms are configured to diffract a second portion of the image light out of the optical path.

7. The optical system of claim 6, further comprising:
a light sink, wherein the first and second holograms are configured to diffract the second portion of the image light towards the light sink.

8. The optical system of claim 6, wherein the first and second holograms are each configured to diffract the image light a plurality of times.

9. The optical system of claim 1, wherein the optical coupler comprises an output coupler configured to couple the image light out of the waveguide.

10. The optical system of claim 1, wherein the optical coupler comprises a coupler selected from the group consisting of: an input coupler and a cross coupler.

11. An optical system configured to direct light generated by a display module along an optical path, the optical system comprising:
a waveguide configured to propagate the light via total internal reflection;
a holographic output coupler configured to couple the light out of the waveguide; and
a resolution-enhancing holographic element interposed on the optical path between the display module and the holographic output coupler, wherein the resolution-enhancing optical element is configured to narrow a selectivity curve of the holographic output coupler prior to the holographic output coupler coupling the light out of the waveguide.

12. The optical system of claim 11, wherein the resolution-enhancing holographic element is configured to transmit a first portion of the light along the optical path, wherein the holographic output coupler is configured to couple the second portion of the light out of the waveguide, and wherein the resolution-enhancing holographic element is configured to diffract a second portion of the light away from the optical path.

13. The optical system of claim 12, wherein the selectivity curve of the holographic output coupler has a first primary lobe, wherein the resolution-enhancing holographic element comprises a hologram, wherein the hologram has an additional selectivity curve with a second primary lobe, and wherein the second primary lobe overlaps the first primary lobe.

14. The optical system of claim 13, wherein the holographic output coupler comprises a plurality of holograms.

15. The optical system of claim 13, wherein the hologram of the resolution-enhancing holographic element is configured to diffract the light multiple times.

16. The optical system of claim 15, further comprising:
a layer of grating medium in the waveguide, wherein the holographic output coupler and the resolution-enhancing holographic element are located in the layer of grating medium.

17. The optical system of claim 16, wherein the resolution-enhancing holographic element is located in a first region of the layer of grating medium, wherein the holographic output coupler is located in a second region of the layer of grating medium, and wherein the first and second regions of the layer of grating medium are contiguous.

18. The optical system of claim 11, wherein the holographic output coupler comprises a first set of at least partially-overlapping volume holograms and wherein the resolution-enhancing holographic element comprises a second set of at least partially-overlapping volume holograms.

19. An optical system configured to direct light generated by a display module, the optical system comprising:
a waveguide configured to propagate the light via total internal reflection;
a grating medium in the waveguide;
an output coupler configured to couple the light out of the waveguide, wherein the holographic output coupler comprises:
a first set of holograms in a first region of the grating medium, wherein each of the holograms in the first set at least partially overlaps each of the other holograms in the first set, wherein each of the holograms in the first set has a different respective grating frequency from a first set of grating frequencies, and wherein the holograms in the first set are characterized by a first set of selectivity curves,
a second set of holograms in a second region of the grating medium, wherein each of the holograms in the second set at least partially overlaps each of the other holograms in the second set, wherein each of the holograms in the second set has a different respective grating frequency from a second set of grating frequencies, the second set of grating frequencies being located within adjacent frequency gaps between the grating frequencies in the first set of grating frequencies, and wherein the holograms in the first set are characterized by a second set of selectivity curves; and
a third set of holograms in a third region of the grating medium, wherein the first region is interposed between the second and third regions of the grating medium, and wherein the third set of holograms is configured to narrow each of the selectivity curves in the first set of selectivity curves.

20. The optical system of claim 19, wherein the third set of holograms is configured to narrow each of the selectivity curves in the second set of selectivity curves.
